(19) United States
(12) Patent Application Publication
(10) Pub. No.: US 2006/0028956 A1
(43) Pub. Date: Feb. 9, 2006

(54) Optical pickup and information processing device

(75) Inventors: Jun Togashi, Kawagoe-shi (JP); Shigeru Kojima, Kawagoe-shi (JP); Hideki Kinoshita, Kawagoe-shi (JP); Akira Yasaki, Kawagoe-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 11/086,672

(22) Filed: Mar. 23, 2005

(30) Foreign Application Priority Data
Mar. 24, 2004 (JP) 2004-087465

(51) Int. Cl. G11B 7/00

(52) U.S. Cl. 369/110.01; 369/112.01

(57) ABSTRACT

An optical pickup 200 is arranged between optical discs 10A and 10B rotatably supported with the recording surfaces 10Aa and 10Ba facing each other, the optical pickup being movable along the recording surfaces 10Aa and 10Ba. A laser beam of two wavelengths emitted from a semiconductor laser 201 is respectively reflected in opposite directions by a polarized beam splitter. The reflected laser beams are respectively condensed on the recording surfaces 10Aa and 10Ba via objective lenses, and the laser beam traveling back along the same optical axis is received and processed. No moving member is required, which enables downsizing.

### BACKGROUND OF THE INVENTION

1. Field of the Invention

The present invention relates to an optical pickup and an information processing device for reading information recorded on an optical recording medium or recording information on an optical recording medium.

2. Description of Related Art

There has been known an information processing device provided with an optical pickup to perform information processing such as reading information recorded on an optical recording media such as CD (Compact Disc) and DVD (Digital Versatile Disc) and recording information thereon. In addition, there has been also known an information processing device which stores a plurality of optical recording media and drives these optical recording media with a single pickup (see, for example, Japanese Patent Laid-open Publication No. Hei 11-273109, the left column of Page 3 and FIG. 1).

The above publication discloses the optical pickup which can record information on and reproduce information from the recording surface of respective recording media by irradiating a laser beam onto the plurality of recording media. The optical pickup has a Galvano mirror which reflects laser beams from a light source selectively toward either one of the plurality of recording media. The laser beam emitted from the light source can be reflected on the recording surface of other recording media by rotating the Galvano mirror by a predefined angle.

Here, since an optical path is defined by rotating the Galvano mirror in the conventional optical pickup as described in the above Patent Document 1 (Translator's comment: correctly, above publication), a space is in accordance with a rotation track of the Galvano mirror. Accordingly, it is difficult to downsize optical pickups, which is an example of problems in such a conventional arrangement.

### SUMMARY OF THE INVENTION

An object of the present invention is to provide an optical pickup which can be easily downsized and an information processing device.

An optical pickup according to an aspect of the present invention includes: a light source; a polarizer for polarizing a light emitted from the light source; a polarization direction changer for selectively switching a polarization direction of the light polarized by the polarizer; an optical member for changing a direction of an optical axis of the light according to the polarization direction switched by the polarization direction changer; and a plurality of condensers disposed on the changed optical axis for respectively condensing the light on recording surfaces of separate optical recording media.

An optical pickup according to another aspect of the present invention includes: a light source for emitting a light of different wavelengths; an optical member for changing a direction of an optical axis of the light depending on the wavelengths; and a plurality of condensers disposed on the changed optical axis for respectively condensing the light on recording surfaces of separate optical recording media.

An optical pickup according to still another aspect of the present invention includes: a light source; an optical member for splitting a light emitted by the light source toward different directions; a plurality of condensers disposed on the split optical axis for respectively condensing the light on recording surfaces of separate optical recording media; and a plurality of light receivers for respectively receiving the light reflected by the optical recording media.

An information processing device according to yet another aspect of the present invention includes: the above-mentioned optical pickup of the present invention; and a moving unit for relatively moving at least either the optical pickup or the plurality of optical recording media so that the optical pickup is positioned along the recording surface of the optical recording medium.

An information processing device according to further aspect of the present invention includes: the above-mentioned optical pickup of the present invention; a rotation supporter for rotatably supporting a plurality of disc-shaped recording media each having a recording surface at least on one side thereof in a layered manner; and a moving unit for moving the optical pickup radially along the recording surface.

An information processing device according to still further aspect of the present invention includes: a rotation supporter for rotatably supporting a plurality of disc-shaped recording media each having a recording surface at least on one side with the recording surfaces facing each other; and the above-mentioned optical pickup of the present invention located between the disc-shaped recording media and disposed to be movable along the recording surface.

An information processing device according to yet further aspect of the present invention includes: a rotation supporter for rotatably supporting disc-shaped recording media each having a recording surface at least on one side with the recording surfaces oriented in the same direction; and the above-mentioned optical pickup of the present invention arranged so that the condensers are disposed to be movable along the recording surfaces of the disc-shaped recording media.

### BRIEF DESCRIPTION OF THE DRAWINGS

FIG. 1 is a cross section schematically illustrating a disc device according to a first embodiment of the present invention;

FIG. 2 is a plan view schematically illustrating an optical path of light emitted by an optical pickup in the first embodiment;

FIG. 3 is another plan view schematically illustrating the optical path of the light emitted by the optical pickup in the first embodiment;

FIG. 4 is a cross section schematically illustrating a disc device according to a second embodiment of the present invention;

FIG. 5 is a plan view schematically illustrating an optical path of a light emitted by an optical pickup in the second embodiment;

FIG. 6 is a plan view schematically illustrating the optical path of the light according to another embodiment of the present invention;

FIG. 7 is another plan view schematically illustrating the optical path of the light in the embodiment of FIG. 7 (Translator's comment: correctly, FIG. 6);

FIG. 8 is a plan view schematically illustrating an optical path of a light according to still another embodiment of the present invention;

FIG. 9 is another plan view illustrating the optical path of the light in the embodiment of FIG. 8;

FIG. 10 is a plan view illustrating an optical path of a light according to yet another embodiment of the present invention;

FIG. 11 is another plan view illustrating the optical path of the light in the embodiment of FIG. 10;

FIG. 12 is a plan view illustrating an optical path of a light according to further embodiment of the present invention;

FIG. 13 is another plan view illustrating the optical path of the light in the embodiment of FIG. 12;

FIG. 14 is a plan view illustrating an optical path of the light according to still further embodiment of the present invention; and

FIG. 15 is another plan illustrating the optical path of the light in the embodiment of FIG. 14.

### DETAILED DESCRIPTION OF PREFERRED EMBODIMENT(S)

### First Embodiment

(Arrangement of Disc Device)

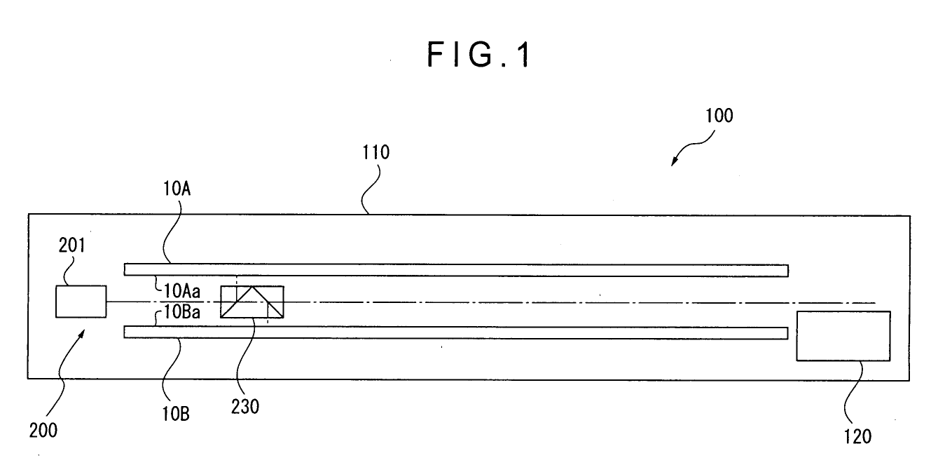

The reference numeral 100 in FIG. 1 is a disc device, arranged as a device to be installed in a playback device for reproducing information such as, for example, image data or music data. The disc device 100 performs a read process for reading information recorded on recording surfaces 10Aa and 10Ba respectively provided on at least one side of circular optical discs 10A and 10B serving as disc-shaped recording media, which are optical recording media detachably loaded, and a recording process for recording various information on the recording surfaces 10Aa and 10Ba. The disc device 100 has a substantially rectangular box-shaped casing body 110, which is, for instance, made of metal with an internal space and has an opening on one side thereof which is closable by, for example, a cover. Additionally, a tray member (not shown), a carrier (not shown) for advancing/retracting the tray member through the opening of the casing body 110, and a control circuitry 120 for controlling the overall action of the disc device 100 are disposed in the casing body 110. Although a tray type disc device 100 in which the optical discs 10A and 10B are mounted on the tray member is exemplified here as the disc device 100, other arrangements may also be employed such as so-called slot-in type disc device having a slit-shaped opening which allows the optical discs 10A and 10B to be directly inserted into the disc device 100.

The tray member has a generally plate-shaped tray (not shown) made of synthetic resin or the like, and a decorative sheet (not shown) made of synthetic resin or the like formed into an elongated board and disposed at an edge of the tray for closing the opening of casing body 110 in a state where the tray member is retracted inside the casing body 110 by the carrier. The tray has a loading opening formed in the substantially central portion thereof. The tray member has a disc processor (not shown) disposed with its portion exposed to the loading opening. Two tray members are provided in the disc device 100. The tray members are disposed so that the recording surfaces of the loaded optical discs 10A and 10B face each other. Incidentally, although two tray members corresponding to the optical discs 10A and 10B are provided, the arrangement is not limited thereto. For example, a single tray member may be provided for chucking the optical discs 10A and 10B on its both sides.

The carrier advances and retracts the tray member. For example, when an ejection signal of the tray is output from the control circuitry 120 by operation of an eject button or the like, the carrier 500 (Translator's comment: the reference numeral 500 should be deleted) advances the tray through the opening. Then, after moving the tray member into the disc device 100 by a predefined distance in a state where the tray member has been advanced, the carrier retracts the tray member to automatically house the tray member inside. In addition, when the tray member is housed inside, a clutch nail (not shown) clutches the tray member in order to prevent the tray from advancing and retracting.

The disc processor has a frame-shaped pedestal (not shown). An optical disc rotation driver (not shown) is disposed in the pedestal. The optical disc rotation driver has an electric motor (not shown) for rotation which is a spindle motor and a turn disc (not shown) acting as a rotation supporter disposed integrally with an output shaft of the electric motor for rotation. The turn disc rotatably holds the optical discs 10A and 10B with their recording surfaces 10Aa and 10Ba facing each other.

In addition, the pedestal has a processing moving unit provided as a moving unit (not shown). The processing moving unit has, for instance, a pair of guide shafts (not shown) disposed in the pedestal with their axial directions being generally parallel, and an electric motor for movement such as a stepping motor. A lead screw having a spiral engagement groove formed on its peripheral surface is integrally and coaxially coupled to an output shaft (not shown) of the electric motor for movement.

Furthermore, an information processing device (not shown) supported by the processing moving unit is disposed in the pedestal. The information processing device has a movement holder (not shown) held between a pair of guide shafts in a bridging manner. The movement holder has a holder (not shown) into which the guide shaft fits movably and a movement restriction nail (not shown) engaging with the engagement groove of the lead screw coupled to the output shaft of the electric motor for movement. In addition, the movement holder of the information processing device has an optical pickup 200 connected to the control circuitry 120 so that signals can be transmitted and received, which performs a read process to read various kinds of information recorded on the recording surfaces of the optical discs 10A and 10B and output the information to the output circuitry and a recording process to record various kinds of information from the control circuitry 120 on the recording surfaces under control of the control circuitry 120. The optical pickup 200 is attached so as to move in a radial direction of the optical discs 10A and 10B along the recording surfaces 10Aa and 10Ba of the optical discs 10A and 10B by the above-mentioned processing moving unit.

The control circuitry 120 is arranged, for example, as a circuitry on a circuit board on which various electric components are installed. The control circuitry 120 has a drive controller for controlling the action of the optical pickup 200, an information processing device for performing information processing such as a read or a record process, and a light quantity controller for adjusting the light quantity of the laser beam.

(Arrangement of Optical Pickup)

Next, the arrangement of the optical pickup 200 of the above-described disc device 100 will be described in details with reference to FIGS. 1 to 3. Although the arrangement of the optical pickup 300 (Translator's comment: correctly, 200) exemplified here can perform information processing of both the CDs (Compact Disc) and DVDs (Digital Versatile Disc) as the optical discs 10A and 10B, arrangements applicable to either one of the recording media can also be employed as mentioned above. In addition, although an arrangement using a light source which can emit outgoing beams of two wavelengths, i.e. a CD laser beam and a DVD laser beam is exemplified, any arrangements may be employed such as the arrangement using a single light source which can emit outgoing beams of further wavelengths; the arrangement using, for instance, a single light source which can emit only a single-wavelength beam such as a light source emitting the CD laser beam; and the arrangement using a plurality of the light sources and a plurality of light beams are processed to have the same optical axis by a dichroic prism as an optical member.

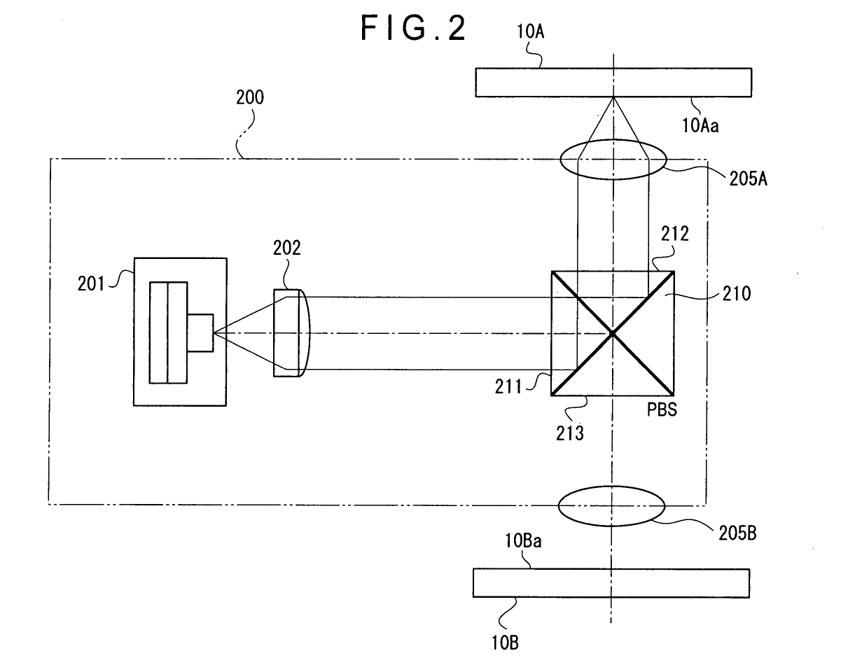

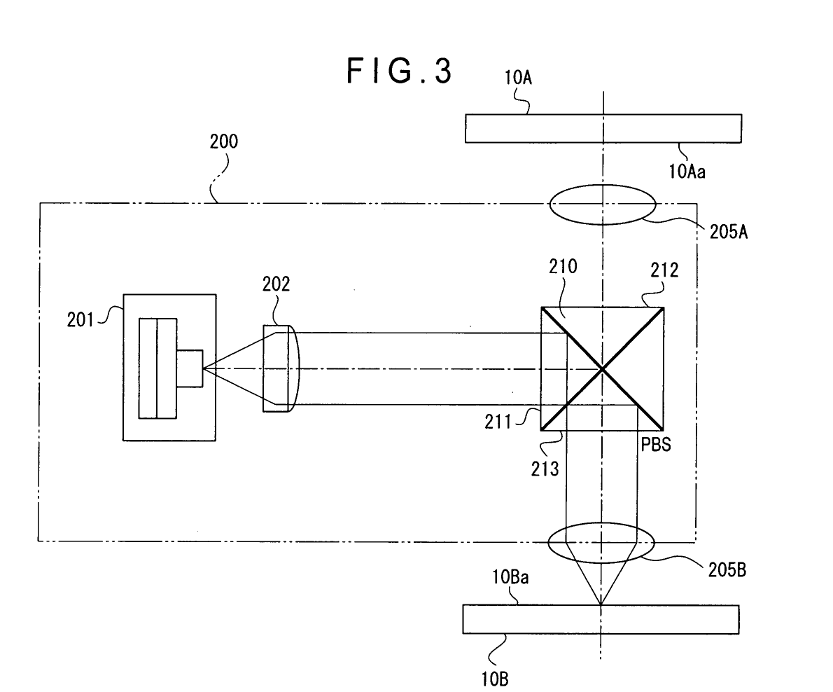

The optical pickup 200 has a holder (not shown). The holder is provided with a semiconductor laser 201 acting as a light source for emitting the laser beam to irradiate the optical discs 10A and 10B as shown in FIGS. 2 and 3. The semiconductor laser 201 emits, for example, two types of the beams having different wavelengths, i.e. the CD laser beam and DVD laser beam. Incidentally, the laser beams of two wavelengths are arranged so that both may be simultaneously emitted, or a laser beam having either one wavelength may be emitted.

Disposed in proximity to the semiconductor laser 201 is a hologram (not shown) as the optical path splitting member. The hologram transmits the laser beam emitted from the semiconductor laser 201 and changes the optical axis direction of the laser beams reflected by the optical discs 10A and 10B and traveling along the same optical axis by a predefined angle according to their wavelengths. Also disposed in the changed direction of the optical axis is a light receiving member as the light receiver (not shown). The light receiving member receives the light with the optical axis direction having changed by the hologram, generates a signal according to the information included in the light, and outputs the signal to the control circuitry 120.

In addition, the holder has a grating (not shown) disposed in proximity to the emitting side of the semiconductor laser 201. Furthermore, the holder has a collimator lens 202 on which the laser beam is incident after having been transmitted through the grating.

A polarized beam splitter (PBS) 210 is disposed in the holder as an optical member. The polarized beam splitter 210 lets the laser beams emitted from the semiconductor laser 201 be incident on a surface 211, and then splits the optical paths according to the difference of the wavelengths of the laser beams. For instance, if the optical disc 10A is a CD and the optical disc 10B is a DVD, the polarized beam splitter 210 emits a laser beam having a CD wavelength from a surface 212 of the polarized beam splitter 210 as shown in FIG. 2 and emits a laser beam having a DVD wavelength from a surface 213 as shown in FIG. 3.

In addition, the optical pickup 200 includes objective lenses 205A and 205B as condensers that are held by a lens holder (not shown). One objective lens 205A is disposed to be movable along the optical axis and along a radial direction which is the tracking direction orthogonal to the optical axis direction in a manner facing the surface 212 of the polarized beam splitter 210. Similarly, the other objective lens 205B is disposed to be movable along the optical axis and along the radial direction which is the tracking direction orthogonal to the optical axis direction in a manner facing the surface 213 of the polarized beam splitter 210. Then, the laser beams condensed on the optical discs 10A and 10B respectively by the objective lenses 205A and 205B are reflected in accordance with the information recorded on the recording surfaces 10Aa and 10Ba of the optical discs 10A and 10B.

The reflected light travels in a reverse direction along the optical path, which is incident the hologram disposed in proximity to the semiconductor laser 201 as described above and then emitted toward the light receiving member at a predefined angle according to the polarization direction.

(Operation of Disc Device)

Next, the operation of the disc device 100 will be described.

In the optical pickup 300 (Translator's comment: correctly, 200), the laser beam emitted from the semiconductor laser 201 is transmitted through the grating and the collimator lens 202 to be converted into generally parallel light beams. The polarized beam splitter 210 emits the laser beam from a predefined surface according to the wavelength of the laser beam emitted from the semiconductor laser 201. For example, suppose the optical disc 10A is a CD and the optical disc 10B is a DVD as stated above. In this case, the polarized beam splitter 210 emits a laser beam having a CD wavelength from the surface 212 facing the optical disc 10A, whereas the polarized beam splitter 210 emits a laser beam having a DVD wavelength from the surface 213 facing the recording surface of the optical disc 10B.

Then, the objective lenses 205A and 205B condense the laser beams onto the recording surfaces 10Aa and 10Ba of the optical discs 10A and 10B, which are reflected at an angle of reflection according to the information recorded on the recording surface. The reflected laser beam travels along the optical path again and is incident on the hologram disposed in proximity to the semiconductor laser 201. The hologram split the laser beam reflected by the optical discs 10A and 10B at a predefined angle. Then, the light receiving member disposed at a destination of the split beam receives the beam, which is then converted into an electric signal according to the information recorded on the optical discs 10A and 10B.

Additionally, if the laser beams of two wavelengths are simultaneously emitted from the semiconductor laser 201, the polarized beam splitter 210 can also split these laser beams respectively and emit them toward the optical discs 10A and 10B simultaneously. In this case, the read or record process of the optical disc 10A and that of the optical disc 10B are switched to perform every predefined time. For example, the read or the record process of the optical disc 10A is performed for a predefined time length, and the information read in the process is buffered. During the buffering, the read or the record process of the optical disc 10B is performed. When buffering of the information read from the optical disc 10A is finished, the read or the record process of the optical disc 10A is performed again while the information read from the optical disc 10B is buffered.

Furthermore, respective signals can be simultaneously processed for each wavelength by using an element which receives light according to the wavelength. For example, to record information read from one disc (i.e. the optical disc 10A) into the other one (i.e. the optical disc 10B) or the like can be exemplified.

(Effect of First Embodiment)

As stated above, the optical pickup 200 of the above embodiment has the semiconductor laser 201 for emitting laser beams having different wavelengths, the polarized beam splitter 210 for changing the optical path direction along which the laser beams are emitted in accordance with the difference of the wavelengths of the laser beams, and the objective lenses 205A and 205B respectively disposed on the changed optical axis. Accordingly, the surface of the polarized beam splitter 210 from which the laser beam is emitted can be selected by selecting a laser beam to be emitted from the semiconductor laser 201. Therefore, the complicated rotation mechanism of the Galvano mirror as in the conventional technology is not required, and laser beams irradiating respective optical discs 10A and 10B can be switched by a simple arrangement which only requires to change the wavelength of the laser beam emitted from the semiconductor laser 201, thereby enabling downsizing of the optical pickup 200. Furthermore, since the optical path of the laser beam is optically split or switched by the polarized beam splitter 210, the optical path can be continuously and stably changed without breaking as compared with the conventional technology in which the optical path is mechanically changed.

In addition, the polarized beam splitter 210 splits the laser beam. Accordingly, it may be sufficient that the polarized beam splitter 210 is fixed in a predefined direction relative to the holder, thereby eliminating the necessity of other complicated arrangements such as the conventional rotation mechanism. Thus, the arrangement can be simplified, resulting in a reduced manufacturing cost.

The disc device 100 having the above-described optical pickup 200 includes a processing moving unit for moving the optical pickup 200 radially along the recording surfaces 10Aa and 10Ba of the optical discs 10A and 10B With the arrangement, the optical pickup 200 can move along both recording surfaces 10Aa and 10Ba of the optical discs 10A and 10B. Accordingly, reading information recorded on both recording surfaces 10Aa and 10Ba of the optical discs 10A and 10B or recording information on the recording surfaces 10Aa and 10Ba can be performed efficiently.

In addition, the turn disc of the disc device 100 rotatably holds the optical discs 10A and 10B so that their recording surfaces 10Aa and 10Ba face each other with the optical pickup 200 disposed between these optical discs 10A and 10B. Accordingly, the single semiconductor laser 201 and the single polarized beam splitter 210 of the optical pickup 200 will be sufficient for handling two optical discs 10A and 10B. Therefore, the number of optical components can be reduced, enabling downsizing of the optical pickup 200.

Additionally, the optical pickup 200 is interposed between the optical discs 10A and 10B. Thus, the optical pickup 200 can utilize the space between the pair of optical discs 10A and 10B efficiently. Moreover, since the optical pickup 200 can be disposed in a position closer to the optical discs 10A and 10B, the arrangement of the optical pickup can be simplified.

Furthermore, the optical discs 10A and 10B are loaded so that their recording surfaces face each other. Accordingly, laser beams can be easily irradiated on both the optical discs 10A and 10B by providing the objective lenses on both sides of the optical pickup 200. Thus, the arrangement can further be simplified, enabling the optical pickup to be further downsized.

Additionally, the hologram is disposed in proximity to the semiconductor laser 201, so that the laser beam reflected by the optical discs 10A and 10B is split by the hologram and received by the light receiving member. With the arrangement, the laser beam reflected by the optical discs 10A and 10B is prevented from being incident on the semiconductor laser 201, so that only the reflected laser beam may be split. Furthermore, by forming the hologram integrally with the semiconductor laser 201, the light receiving member does not have to be provided separately. Thus, efficient utilization of space can be achieved, thereby resulting in downsizing the optical pickup.

### Second Embodiment

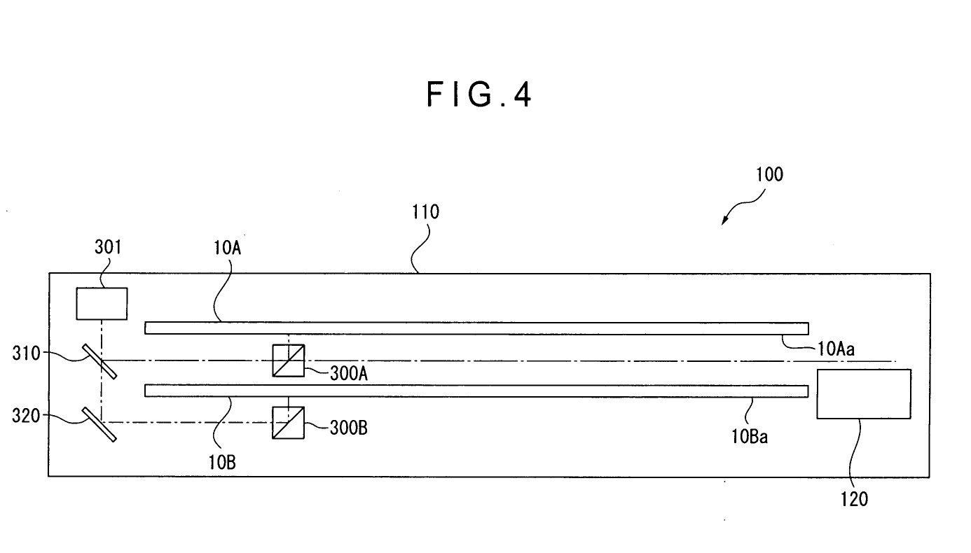

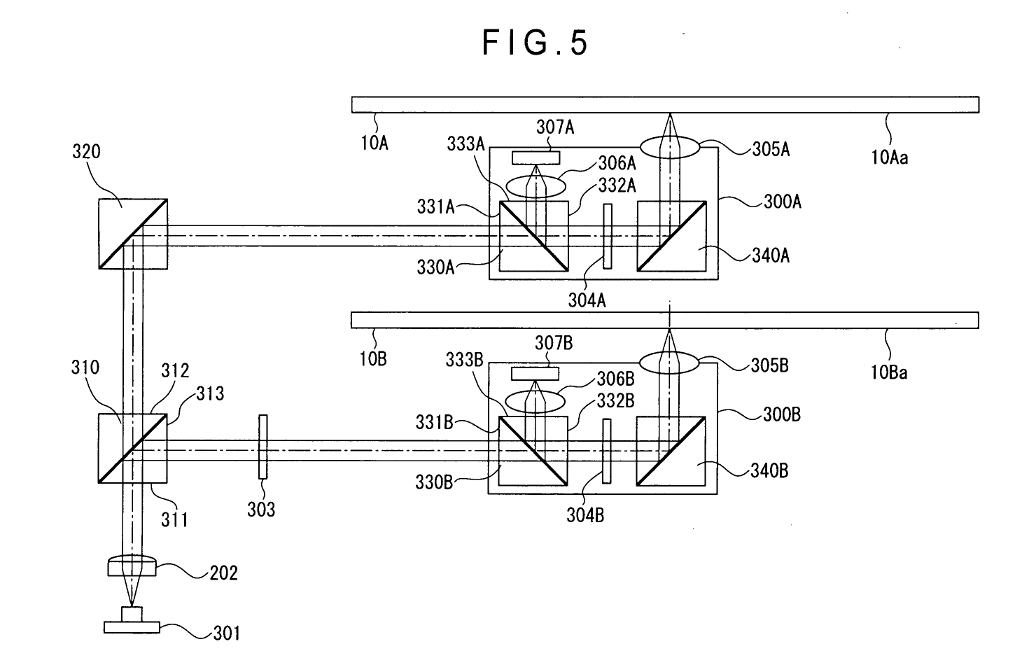

Next, a disc device according to a second embodiment of the present invention will be described with reference to the attached drawings. FIG. 4 is a cross section schematically illustrating the disc device according to the second embodiment. FIG. 5 is a plan view schematically illustrating an optical path of an optical pickup.

In the second embodiment, although a disc device which reads information from and records information on the optical disc as a disc-shaped recording medium detachably loaded as with the first embodiment, it may perform a read-only or record-only process of information. In addition, as the disc-shaped recording medium, disc-shaped recording medium such as magneto-optical discs may also be employed without limiting to the optical disc. Furthermore, any types of recoding media such as cylindrical recording medium having a recording surface on the peripheral surface, or integrally built-in recording medium may be employed.

(Arrangement of the Disc Device)

The disc device 100 (Translator's comment: correctly, 100A) according to the second embodiment has two tray members as with the first embodiment. Also, the disc device 100 (Translator's comment: correctly, 100A) of the second embodiment is arranged so that the optical discs 10A and 10B are loaded in the tray member with their recording surfaces 10Aa and 10Ba oriented in the same direction as shown in FIG. 4.

(Arrangement of Optical Pickup)

Next, an arrangement of the optical pickup 300 of the disc device 100 (Translator's comment: correctly, 100A) according to the second embodiment will be described in detail referring to FIG. 5.

The optical pickup 300 has a holder (not shown), a pickup section 300A disposed on a position facing the recording surface of the optical disc 10A, and a pickup section 300B disposed on a position facing the recording surface of the optical disc 10B. The pickup sections 300A and 300B are disposed in a manner respectively movable in a radial direction of the recording surfaces 10Aa and 10Ba of the optical discs 10A and 10B by a processing moving unit similar to that of the first embodiment. A semiconductor laser 301 disposed on the holder. The semiconductor laser 301 is disposed, for example, at a position apart from the pickup sections 300A and 300B and emits laser beams along the axial direction of the optical discs 10A and 10B. A grating (not shown) is disposed in proximity to the semiconductor laser 301. In addition, the holder has the collimator lens 202 on which the laser beam is incident after having been transmitted through the grating.

The holder also has a first polarized beam splitter 310 serving as an optical member for emitting a portion of the laser beam emitted from the semiconductor laser 301 toward the pickup section 300B. The first polarized beam splitter 310 lets the laser beam emitted from the collimator lens 202 to be incident on a surface 311. The polarized beam splitter 310 then reflects the laser beam having a predefined polarization direction to be emitted from a surface 313 and transmits other laser beams to be emitted from a surface 312.

In addition, the holder has a mirror 320 disposed via the polarized beam splitter 310 on an extension in the emission direction of the semiconductor laser 301. The laser beam emitted from the surface 312 of the first polarized beam splitter 310 is reflected by the mirror 320 and emitted toward the pickup section 300A.

On the other hand, the holder has a wave plate 303 disposed in proximity to the surface 313 of the first polarized beam splitter 310. The wave plate 303 changes the polarization direction of the laser beam so that the laser beam emitted from the surface 313 of the polarized beam splitter 310 can be transmitted through a second polarized beam splitter 330B (described later) serving as an optical member. The laser beam with the polarization direction having been changed by the wave plate 303 is emitted toward the pickup section 300B.

The pickup section 300A has a second polarized beam splitter 330A serving as an optical member, a quarter-wave plate 304A, an objective lens 305A, a cylinder lens 306A, and a light receiving element 307A integrally provided thereon. The second polarized beam splitter 330A lets the laser beam emitted from the mirror 320 be incident on a surface 331A, the laser beam transmitted through and emitted from a surface 332A. The quarter-wave plate 304A then adjusts the polarization direction of the laser beam emitted from the surface 332A of the second polarized beam splitter 330A and emits the laser beam toward a mirror 340 (Translator's comment: correctly, mirror 340A). The mirror 340A reflects the laser beam toward the objective lens 305A.

On the other hand, the light receiving element 307A serving as a light receiver is disposed via the cylinder lens 306A at a position facing a surface 333A from which the laser beam having been incident on the surface 332A of the second polarized beam splitter 330A and reflected by the optical disc 10A is emitted. The light receiving element 307A receives the outgoing beam which is reflected by the optical disc 10A. In other words, the second polarized beam splitter 330A transmits the laser beam from the semiconductor laser 301, reflects the laser beam reflected from the optical disc 10A, and emits the laser beam toward the light receiving element 307A. The light receiving element 307A outputs a signal corresponding to the received outgoing beam to the control circuitry 120. The control circuitry 120 then suitably performs information processing based on the signal corresponding to the received laser beam. Specifically, the control circuitry 120 recognizes and suitably reproduces the information recorded on the recording surface of the optical disc 10A.

In addition, as with the pickup section 300A, the pickup section 300B has the second polarized beam splitter 330B, a quarter-wave plate 304B, a mirror 340B, an objective lens 305B, a cylinder lens 306B, and a light receiving element 307B integrally provided thereon. The second polarized beam splitter 330B lets the laser beam emitted from the wave plate 303 be incident on a surface 331B, the laser beam transmitted through and emitted from a surface 332B. Then, the quarter-wave plate 304B disposed in proximity to the surface 332B adjusts the polarization direction of the laser beam and emits the laser beam toward the mirror 340B. The mirror 340B reflects the laser beam toward the objective lens 305B. The objective lens 205B (Translator's comment: correctly, 305B) condenses the laser beam on the recording surface 10Ba of the optical disc 10B.

On the other hand, the light receiving element 307B serving as a light receiver is disposed via the cylinder lens 306B at a position facing a surface 333B from which the laser beam having been incident on the surface 332B of the second polarized beam splitter 330B and reflected by the optical disc 10B is emitted. The light receiving element 307B receives the outgoing beam which is reflected by the optical disc 10B. In other words, the third polarized beam splitter 330B (Translator's comment: correctly, second polarized beam splitter 330B) transmits the laser beam from the semiconductor laser 301, reflects the laser beam reflected from the optical disc 10B, and emits the laser beam toward the light receiving element 307B. The light receiving element 307B outputs a signal corresponding to the received outgoing beam to the control circuitry 120. The control circuitry 120 then suitably performs information processing based on the signal corresponding to the received laser beam. Specifically, the control circuitry 120 recognizes and suitably reproduces the information recorded on the recording surface of the optical disc 10B.

(Operation of Disc device)

Next, the operation of the above-mentioned disc device 100A will be described.

In the optical pickup 300, the laser beam emitted from the semiconductor laser 201 is transmitted through the grating and the collimator lens 202 to be converted into a generally parallel light beams. The polarized beam splitter 310 then reflects the laser beam having a predefined polarization direction to be emitted from the surface 313 and transmits other laser beams to be emitted from the surface 312. The laser beam emitted from the surface 312 is reflected by the mirror 320 and emitted toward the pickup section 300A.

On the other hand, the laser beam reflected by the first polarized beam splitter 310 and emitted from the surface 313 is transmitted through the wave plate 303. Then, the wave plate 303 adjusts the polarization direction of the laser beam to emit the laser beam toward the pickup section 300B.

In the pickup sections 300A and 300B, the laser beams transmitted through the second polarized beam splitters 330A and 330B. The laser beam is then reflected by the mirrors 340A and 340B after having transmitted through the quarter-wave plates 304A and 304B, which is condensed on the recording surfaces 10Aa and 10Ba of the optical discs 10A and 10B through the objective lenses 305A and 305B.

In addition, the laser beams reflected by the optical discs 10A and 10B are reflected by the second polarized beam splitters 330A and 330B and received by the light receiving elements 307A and 307B. The light receiving elements 307A and 307B generate an electric signal based on the light quantity or the reflection angle of the received laser beam and output the signal to the control circuitry 120.

(Effect of Second Embodiment)

The disc device 100A of the second embodiment has the semiconductor laser 301, the first polarized beam splitter 310 for splitting the laser beam emitted from the semiconductor laser 301 according to the polarization direction, the objective lenses 305A and 305B for respectively condensing the laser beam split by the first polarized beam splitter 310 on the optical discs 10A and 10B, and the light receiving element 307A and 307B for respectively receiving the laser beam reflected by the optical discs 10A and 10B. With the arrangement, the light receiving elements 307A and 307B can individually receive the laser beam respectively reflected by the optical discs 10A and 10B. Thus, by receiving the information of the optical discs 10A and 10B individually by the two light receiving elements 307A and 307B, complicated arrangements or analysis programs can be eliminated, thereby simplifying the arrangement.

In addition, the objective lens 205A and the light receiving element 307A are integrated with the pickup section 300A, while the objective lens 205B and the light receiving element 307B are integrated with the pickup section 300B. Also, these pickup sections 300A and 300B are disposed movably respectively along the recording surfaces 10Aa and 10Ba of the optical disc 10A and 10B. Accordingly, the pickup sections 300A and 300B can move in a radial direction of the optical disc 10A and 10B individually. Thus, the read process from and write process on the recording surface 10Aa of the optical disc 10A can be performed independently of the read process from and write process on the recording surface 10Ba of the optical disc 10B.

In addition, the turn disc of the disc device 100A rotatably supports the optical discs 10A and 10B so that their recording surfaces 10Aa and 10Ba orient in the same direction. Thus, it is easier to load the optical discs 10A and 10B in the disc device 100 (Translator's comment: correctly, 100A), thereby improving the usability.

[Modifications]

The present invention is not limited to the above specific embodiments, but includes modifications and improvements as long as the objects of the present invention can be attained.

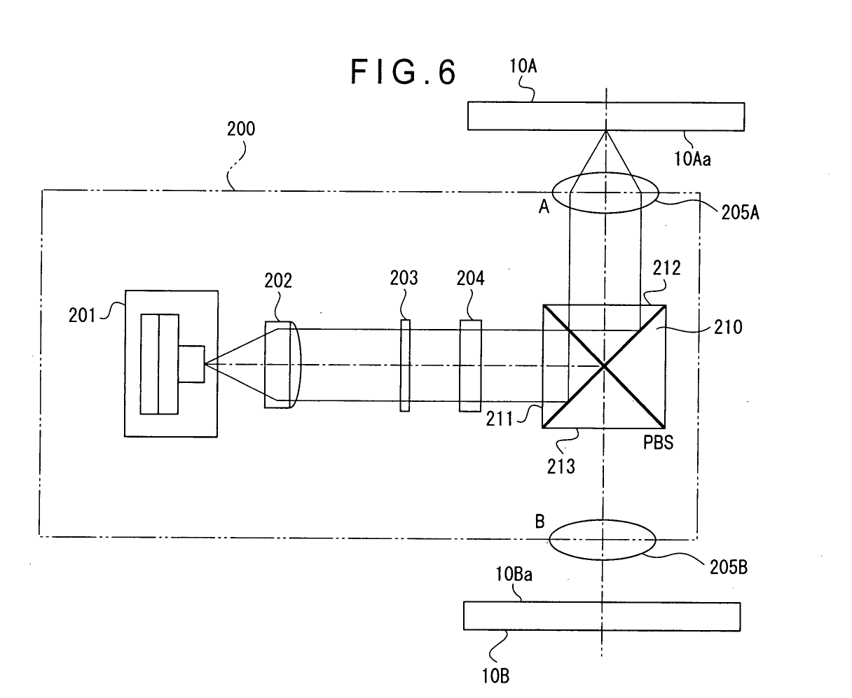

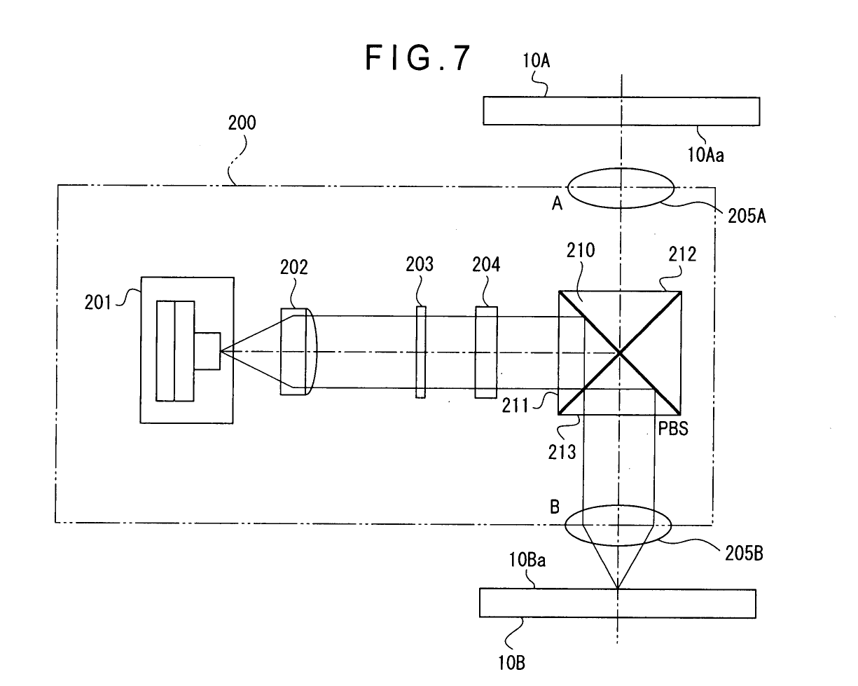

For example, although it has been described in the first embodiment with regard to suitably splitting two different wavelengths, it may be arranged in such a manner that the polarization direction may be suitably split, for example, as shown in FIG. 6 or FIG. 7. In other words, a laser beam having a single wavelength may be emitted from the semiconductor laser 201, and the optical path of the laser beam may be split according to the polarization direction of the laser beam.

In FIGS. 6 and 7, the holder has a polarizing plate 203 disposed adjacent to the collimator lens 202, through which the laser beam is transmitted with its diameter and spreading angle adjusted. The polarizing plate 203 is provided to adjust the wavelength of the transmitted laser beam. Specifically, the laser beam emitted from the semiconductor laser 201 has a waveform of the so-called circularly polarized light which travels spirally. The polarizing plate 203 polarizes the laser beam of the circularly polarized light into a laser beam having a waveform of linearly polarized light oscillating in predefined direction.

Furthermore, the holder has a liquid crystal panel 204 serving as a polarization direction changer disposed in proximity to the polarizing plate 203. The liquid crystal panel 204 selectively changes the direction of the laser beam having transmitted through the polarizing plate 203 into a predefined polarization direction and transmits the laser beam. A wiring (not shown) is connected to the liquid crystal panel 204, is the wiring electrically connected to the control circuitry 120. The control circuitry 120 controls the voltage applied to the liquid crystal panel 204 and enables selection of the polarization direction of the laser beam transmitted through the liquid crystal panel 204.

The holder also has the polarized beam splitter 210 disposed thereon, on which the laser beam with the polarization direction having been changed to a predefined polarization direction is incident. The polarized beam splitter 210 lets the laser beam be incident on the surface 211. Then, the polarized beam splitter 210 emits the laser beam having a predefined polarization direction from the surface 212 while emitting a laser beam having a polarization direction different from that of the laser beam emitted from the surface 212 by, for example, about 90 degrees from the surface 213. In such an arrangement, the laser beam can be condensed on the optical discs 10A and 10B approximately at the same time and processed simultaneously by suitably changing the voltage applied to the liquid crystal panel 204. Thus, since the splitting is performed based on the polarization direction with the same wavelength, even the optical discs 10A and 10B of the same type can be processed.

Although the polarized beam splitter 210 splits the optical path of the laser beam toward the surface 212 and the surface 213 on the opposite side as shown in FIGS. 6 and 7, the arrangement is not limited thereto. For example, the optical path of the laser beam may be split so that the laser beam is emitted from the surface 212 and a surface perpendicular to the surface 212. In other words, the polarized beam splitter 210 may split and reflect the laser beams in a traveling direction toward the polarized beam splitter 210 and in a direction orthogonal to the traveling direction, that is, 90 degrees apart from each other. In this case, the two optical discs 10A and 10B loaded in the disc device 100 are placed with their recording surfaces generally orthogonal to each other. In addition, a mirror may be introduced into the optical path of either one of the laser beams to further reflect the laser beam by 90 degrees, so that the two optical discs 10A and 10B may be placed generally in parallel.

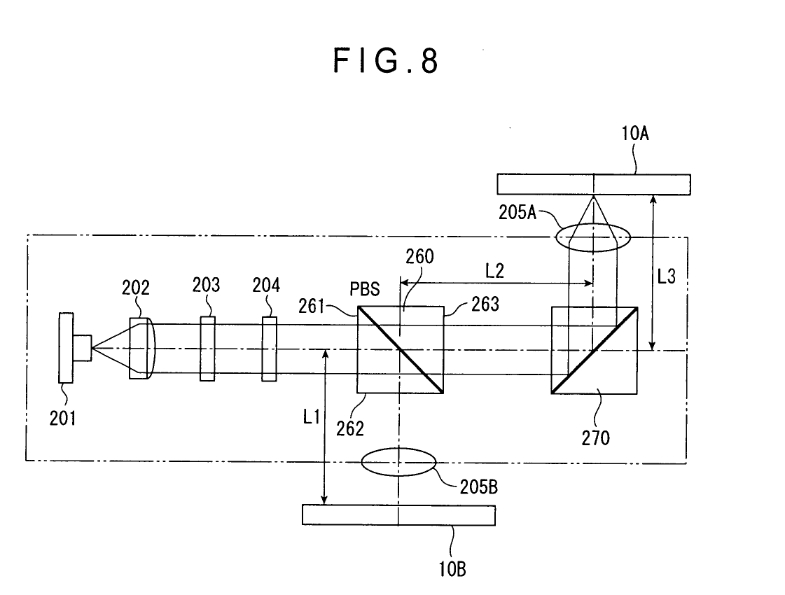

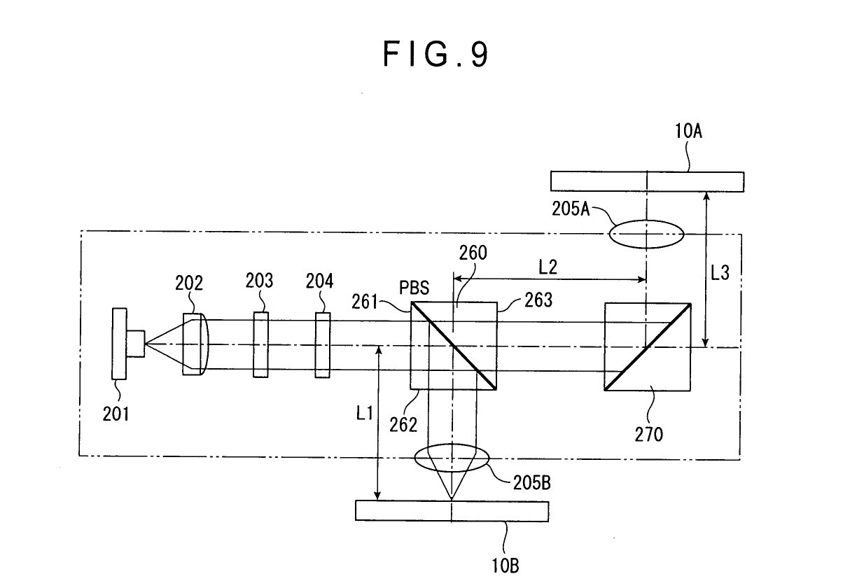

Furthermore, although in the exemplified beam splitter 210 according to the embodiments of the present invention and the modification shown in FIGS. 6 and 7, the laser beam which is incident on the surface 211 is emitted from the surfaces 212 and 213 facing each other according to the difference of the polarization directions, but the arrangement is not limited thereto. For example, an arrangement using a polarized beam splitter 260 as shown in FIGS. 8 and 9 may also be employed.

In FIGS. 8 and 9, the polarized beam splitter 260 reflects, among the laser beams having been incident on a surface 261, the laser beam having a predefined polarization direction to emit from a surface 262. On the other hand, the polarized beam splitter 260 transmits the laser beam having other polarization directions to emit from a surface 263. The laser beam reflected by the polarized beam splitter 260 and emitted from the surface 262 is transmitted through the objective lens 205B and condensed on the optical disc 10B. On the other hand, the laser beam transmitted through the polarized beam splitter and emitted from the surface 263 is reflected by a mirror 270 and transmitted through the objective lens 205A to be condensed on the optical disc 10A.

Incidentally, an optical path length L1 from the surface 262 of the polarized beam splitter 260 to the optical disc 10B is preferably substantially equal to the sum of an optical path length L2 from the surface 263 of the polarized beam splitter 260 to the mirror 270 and an optical path length L3 from the mirror 270 to the optical disc 10A.

In such an arrangement, since only the laser beam with a predefined polarization direction may be reflected among the incident laser beams while transmitting the remaining laser beam, the arrangement of the polarized beam splitter 260 can be simplified. Accordingly, the above-described polarized beam splitter 260 can be producing with low cost, resulting in a reduced production cost.

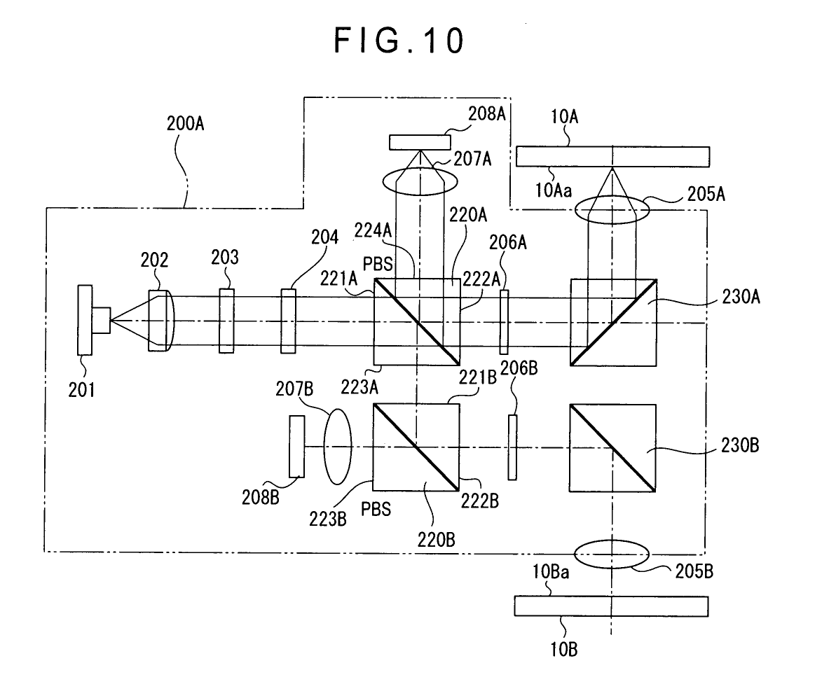

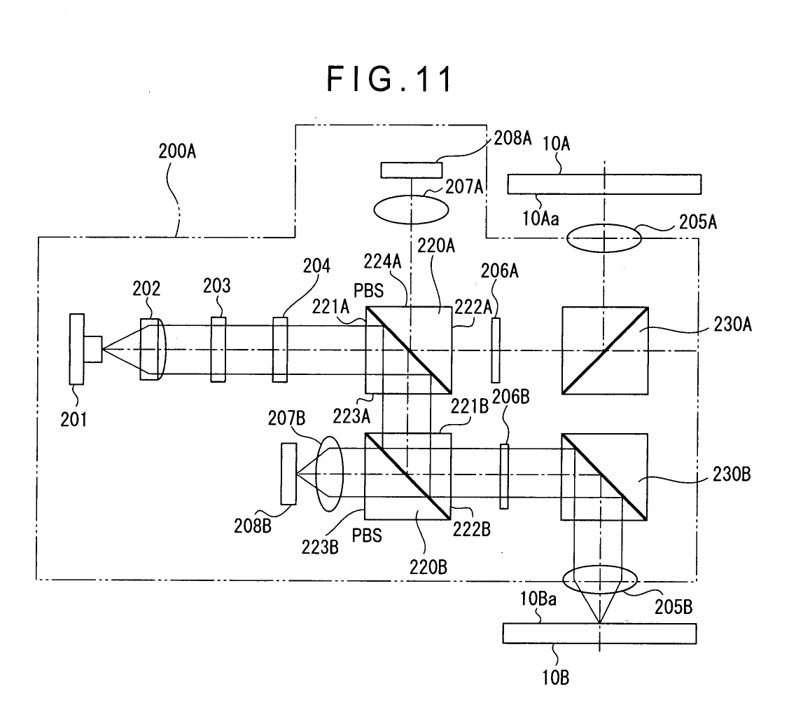

In addition, although the optical pickup 200 in the first embodiment changes with the single polarized beam splitter 210 the directions of the optical paths of the laser beams having different wavelengths respectively into the directions toward the optical disc 10A and toward the optical disc 10B, the arrangement is not limited thereto. For example, as shown in FIGS. 10 and 11, an arrangement having a plurality of polarized beam splitters may also be employed.

In other words, in FIGS. 10 and 11, an optical pickup 200A has the semiconductor laser 201, the collimator lens 202, the polarizing plate 203, the liquid crystal panel 204, a first polarized beam splitter 220A, a second polarized beam splitter 2230B (Translator's comment: correctly, 220B), mirrors 230A and 230B, the objective lenses 205A and 205B, cylinder lenses 207A and 207B, light receiving elements 208A and 208B. The laser beams emitted from the semiconductor laser 201 are converted into a generally parallel light beams by the collimator lens 202, and polarized from a circularly polarized light into a linearly polarized light by the polarizing plate 203. The liquid crystal panel 204 converts the laser beam into the one having a predefined polarization direction. Then, the laser beam with the polarization direction having been changed is incident on a surface 221A of the first polarized beam splitter 220A. The first polarized beam splitter 220A transmits the laser beam from surfaces 222A and 223A according to the polarization direction of the laser beam. For example, if the polarization direction of the laser beam is a so-called P-wave, the laser beam incident on the first polarized beam splitter 220A is transmitted through to be emitted from the surface 222A. On the other hand, if, for example, an S-wave laser beam with a polarization direction different from the P-wave by 90 degrees is incident on the first polarized beam splitter 220A, the laser beam is reflected and emitted from the surface 223A.

The laser beam emitted from the surface 222A of the first polarized beam splitter 220A is transmitted through a quarter-wave plate 206A and reflected by the mirror 230A to be emitted toward the objective lens 205A. The laser beam reflected by the optical disc 10A is reflected by the first polarized beam splitter 220A to be emitted from a surface 224A. The laser beam is then incident on the cylinder lens 207A and the light receiving element 208A which are disposed facing the surface 224A.

In addition, the laser beam emitted from the surface 223A of the first polarized beam splitter 220A is incident on a surface 221B of the second polarized beam splitter 220B. The laser beam incident on the surface 221B is reflected by the second polarized beam splitter 220B to be emitted from a surface 222B. The laser beam emitted from the surface 222B is transmitted through a quarter-wave plate 206B and reflected by the mirror 230B to be condensed on the optical disc 10B by the objective lens 205B. The laser beam reflected by the optical disc 10B is transmitted through the second polarized beam splitter 220B and received by the light receiving element 208B via a collimator lens (not shown) and the cylinder lens 207B.

In such an arrangement, since the first polarized beam splitter 220A changes the direction of the optical path of the laser beam having a single wavelength according to the polarization direction, recording media of the same type may be used as the optical discs 10A and 10B. Even different types of recording media may also be used for the optical discs 10A and 10B by irradiating laser beams of two wavelengths simultaneously from the semiconductor laser. In addition, the mirror 230A and the objective lens 205A may be separated from the holder and attached to be radially movable along the recording surface 10Aa of the optical disc 10A. Similarly, the mirror 230B and the objective lens 205B may be separated from the holder and attached to be radially movable along the recording surface 10Ba of the optical disc 10B. With such arrangement, since the objective lenses 205A and 205B are individually movable, the read and write processes of the optical discs 10A and 10B can be performed at the same time. The light receiving elements 208A and 208B are disposed for individually receiving the laser beams reflected by the optical discs 10A and 10B. Thus, as with the disc device 100A of the second embodiment, complicated arrangements and analysis programs can be eliminated, thereby the arrangement can be simplified.

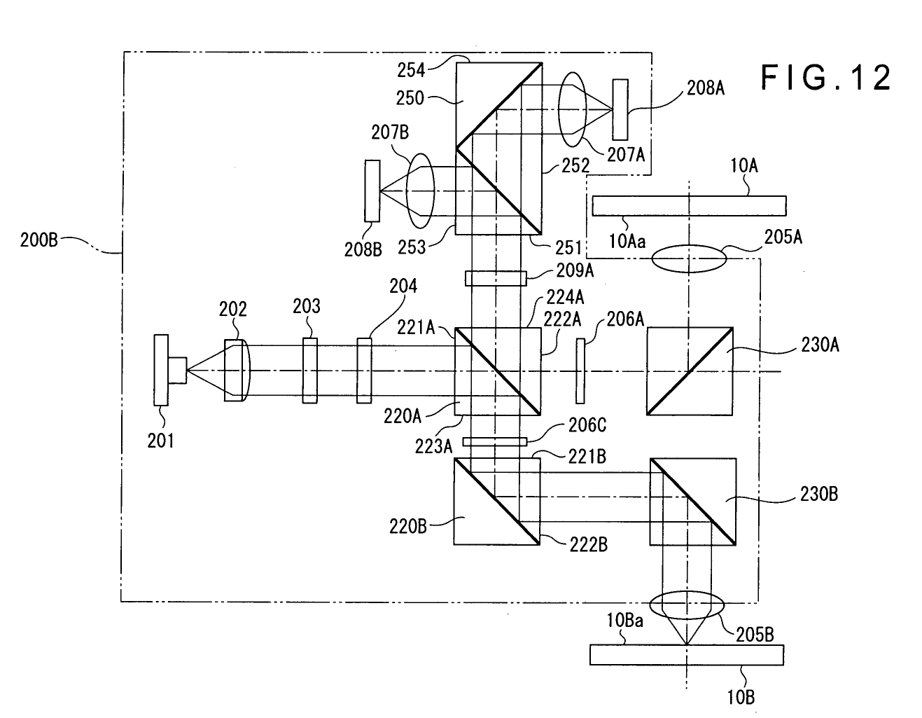

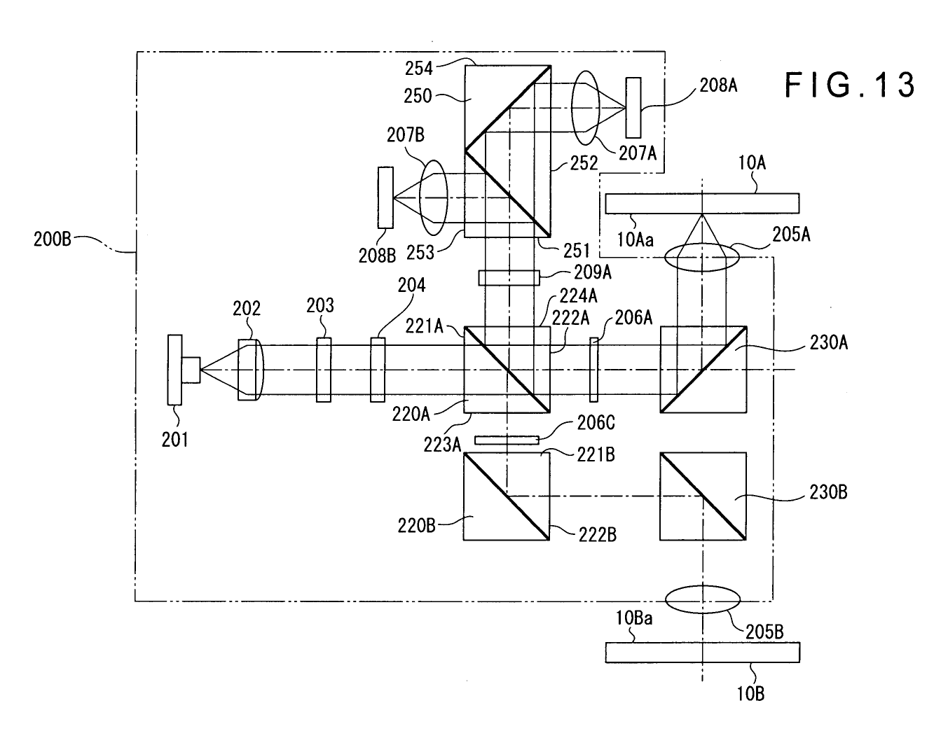

Furthermore, as shown in FIGS. 12 and 13, an arrangement may be employed in which the quarter-wave plate 206B may be removed and a quarter-wave plate 206C may be disposed between the first polarized beam splitter 220A and the second polarized beam splitter 220B. In this arrangement, the laser beam reflected by the optical disc 10B is reflected again at the second polarized beam splitter 220B, transmitted through the quarter-wave plate 206C and incident on the surface 223A of the first polarized beam splitter 220A. The laser beam is then transmitted through the first polarized beam splitter 220A to be emitted from the surface 224A. Here, a wave plate 209 (Translator's comment: correctly, 209A) is disposed facing the surface 224A of the first polarized beam splitter 220A for rotating the polarization direction of the laser beam reflected by the optical disc 10B by about 90 degrees. Then, a third polarized beam splitter 250 is disposed in proximity to the wave plate 209 (Translator's comment: correctly, 209A). The third polarized beam splitter 250 has a reflection surface on the side of a surface 251 on which the laser beam is incident and reflects the laser beam reflected by the optical disc 10B to be emitted from a surface 253. Additionally, the cylinder lens 207B and the light receiving element 208B are disposed facing the surface 253 for receiving the laser beam emitted from the optical disc 10B.

On the other hand, the laser beam reflected by the optical disc 10A is reflected by the first polarized beam splitter 220A, and its polarization direction is changed by the wave plate 209 (Translator's comment: correctly, 209A). The laser beam is then incident on the surface 253 of the third polarized beam splitter 250 to be reflected by a mirror disposed in proximity to a surface 254 on a side opposite to the surface 253 of the third polarized beam splitter, and emitted from a surface 252. The cylinder lens 207A and the light receiving element 208A are disposed in proximity to the surface 252 of the third polarized beam splitter 250 for receiving the laser beam emitted from the surface 252. Incidentally, an arrangement may be employed, where the laser beam reflected by the optical disc 10A is transmitted through the third polarized beam splitter 250 to be emitted from the surface 254 with a cylinder lens 207A and a light receiving element 208A disposed facing the surface 254.

In such an arrangement, since the light receiving elements 208A and 208B can be concentrated around the third polarized beam splitter 250, wiring or the like connected to the light receiving elements 208A and 208B can be organized, so that the space can be used efficiently. Thus, the optical pickup can be downsized efficiently.

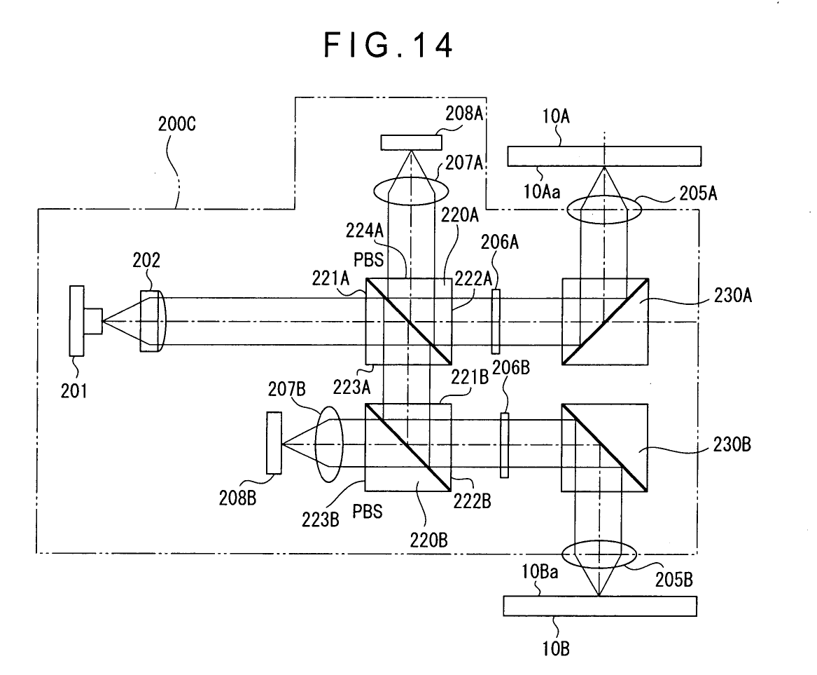

Furthermore, as shown in FIG. 14, the polarizing plate 203 and the liquid crystal panel 204 may be eliminated. In such case, the optical path direction of the laser beam may be changed by the first polarized beam splitter 220A according to the polarization direction, so that the laser beams can be irradiated simultaneously on the optical discs 10A and 10B. Thus, the read and write processes of the optical discs 10A and 10B can be performed more efficiently than by irradiating the laser beam on the optical discs 10A and 10B alternately.

Although an arrangement is described in FIGS. 10 to 14, where the light receiving elements 208A and 208B are disposed for receiving the light reflected by the optical discs 10A and 10B, the arrangement is not limited thereto and the hologram may be disposed in proximity to the semiconductor laser 201 shown in the embodiment. In addition, the semiconductor laser may be integrated with the hologram. In such case, the light receiving elements 208A and 208B, the cylinder lenses 207A and 207B, or the like may be eliminated, resulting in reducing the number of parts and simplifying the arrangement.

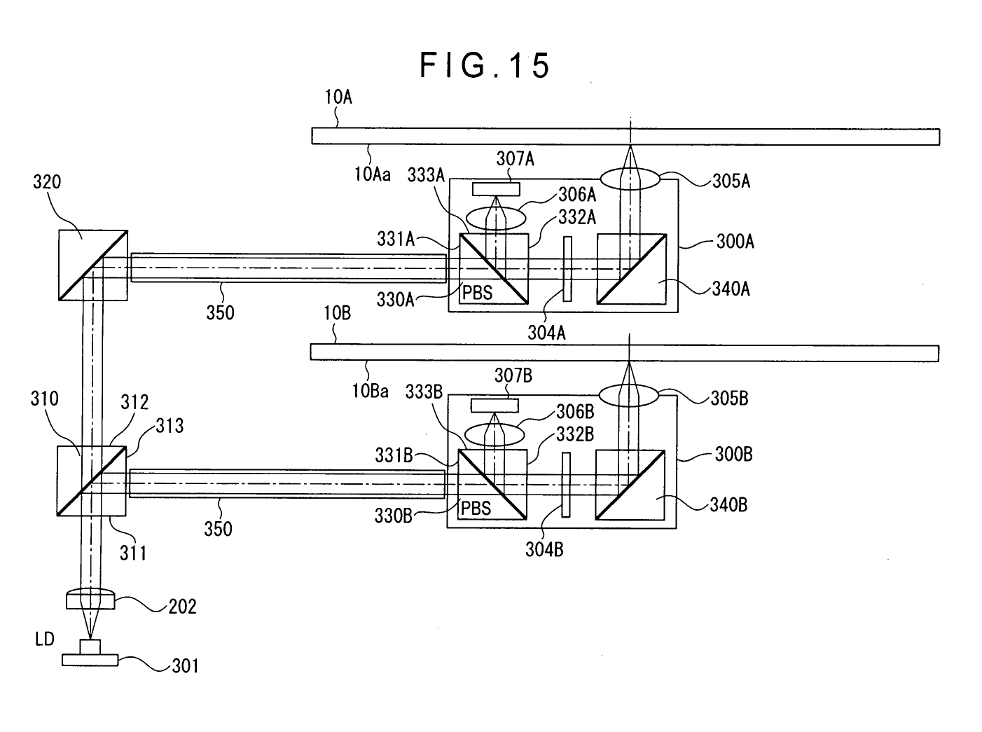

Additionally, in the second embodiment, an optical fiber 350 may be disposed on the optical path of the laser beam as shown in FIG. 15. Although FIG. 15 shows the arrangement providing the optical fiber 350 to the second embodiment, the optical fiber may be provided in the arrangement of the first embodiment. In addition, the optical fiber 350 may be disposed in any position among the optical members. Thus, providing the optical fiber 350 allows the optical path to be freely bent. Accordingly, other members can be disposed in a position typically being on the optical path, thereby enabling downsizing the optical pickup. Furthermore, in the embodiment shown in FIGS. 8 and 9 or the embodiment shown in FIGS. 10 and 11, the optical pickup may be divided and moved respectively as with the pickup sections 300A and 300B of the second embodiment. The optical path can be isolated from the outside by forming the optical path with the optical fiber 350, thereby stabilizing the information processing.

The arrangements and the operating procedures for the present invention may be appropriately modified as long as the scope of the present invention can be attained.

The priority application Number JP2004-087465 upon which this patent application is based is hereby incorporated by reference.

What is claimed is:

1. An optical pickup comprising:
a light source;
a polarizer for polarizing a light emitted from the light source;
a polarization direction changer for selectively switching a polarization direction of the light polarized by the polarizer;
an optical member for changing a direction of an optical axis of the light according to the polarization direction switched by the polarization direction changer; and
a plurality of condensers disposed on the changed optical axis for respectively condensing the light on recording surfaces of separate optical recording media.

2. The optical pickup according to claim 1, wherein the polarization direction changer is a liquid crystal panel.

3. An optical pickup comprising:
a light source for emitting a light of different wavelengths;
an optical member for changing a direction of an optical axis of the light depending on wavelengths; and
a plurality of condensers disposed on the changed optical axis for respectively condensing the light on recording surfaces of separate optical recording media.

4. An optical pickup comprising:
a light source;
an optical member for splitting a light emitted by the light source in different directions;
a plurality of condensers disposed on the split optical axis for respectively condensing the light on recording surfaces of separate optical recording media; and
a plurality of light receivers for respectively receiving the light reflected by the optical recording media.

5. The optical pickup according to claim 4, wherein the optical member is arranged so that the light is split to have a different direction according to a predefined polarization direction.

6. The optical pickup according to claim 1, wherein the optical member is a beam splitter.

7. The optical pickup according to claim 3, wherein the optical member is a beam splitter.

8. The optical pickup according to claim 4, wherein the optical member is a beam splitter.

9. The optical pickup according to claim 1, further comprising a plurality of light receivers for respectively receiving the light reflected by the separate optical recording media among the light condensed by the plurality of condensers.

10. The optical pickup according to claim 3, further comprising a plurality of light receivers for respectively receiving the light reflected by the separate optical recording media among the light condensed by the plurality of condensers.

11. The optical pickup according to claim 4, further comprising a plurality of light receivers for respectively receiving the light reflected by the separate optical recording media among the light condensed by the plurality of condensers.

12. The optical pickup according to claim 4, wherein the condensers and the light receivers are integrally arranged to be movable in pairs along the recording surfaces of the separate optical recording media.

13. An information processing device comprising:
the optical pickup according to claim 1; and
a moving unit for relatively moving at least either the optical pickup or the plurality of optical recording media so that the optical pickup is positioned along the recording surface of the optical recording medium.

14. An information processing device comprising:
the optical pickup according to claim 3; and
a moving unit for relatively moving at least either the optical pickup or the plurality of optical recording media so that the optical pickup is positioned along the recording surface of the optical recording medium.

15. An information processing device comprising:
the optical pickup according to claim 4; and
a moving unit for relatively moving at least either the optical pickup or the plurality of optical recording media so that the optical pickup is positioned along the recording surface of the optical recording medium.

16. An information processing device comprising:
the optical pickup according to claim 1;
a rotation supporter for rotatably supporting a plurality of disc-shaped recording media each having a recording surface at least on one side thereof in a layered manner; and
a moving unit for moving the optical pickup radially along the recording surface.

17. An information processing device comprising:
the optical pickup according to claim 3;
a rotation supporter for rotatably supporting a plurality of disc-shaped recording media each having a recording surface at least on one side thereof in a layered manner; and
a moving unit for moving the optical pickup radially along the recording surface.

18. An information processing device comprising:
the optical pickup according to claim 4;
a rotation supporter for rotatably supporting a plurality of disc-shaped recording media each having a recording surface at least on one side thereof in a layered manner; and
a moving unit for moving the optical pickup radially along the recording surface.

19. An information processing device comprising:
a rotation supporter for rotatably supporting disc-shaped recording media each having a recording surface at least on one side with the recording surfaces facing each other; and
the optical pickup according to claim 1 located between the disc-shaped recording media and disposed to be movable along the recording surface.

20. An information processing device comprising:
a rotation supporter for rotatably supporting disc-shaped recording media each having a recording surface at least on one side with the recording surfaces facing each other; and
the optical pickup according to claim 3 located between the disc-shaped recording media and disposed to be movable along the recording surface.

21. An information processing device comprising:
a rotation supporter for rotatably supporting disc-shaped recording media each having a recording surface at least on one side with the recording surfaces facing each other; and
the optical pickup according to claim 4 located between the disc-shaped recording media and disposed to be movable along the recording surface.

22. An information processing device comprising:
a rotation supporter for rotatably supporting disc-shaped recording media each having a recording surface at least on one side with the recording surfaces oriented in the same direction; and
the optical pickup according to claim 1 arranged so that the condensers are disposed to be movable along the recording surfaces of the disc-shaped recording media.

23. An information processing device comprising:
a rotation supporter for rotatably supporting disc-shaped recording media each having a recording surface at least on one side with the recording surfaces oriented in the same direction; and
the optical pickup according to claim 3 arranged so that the condensers are disposed to be movable along the recording surfaces of the disc-shaped recording media.

24. An information processing device comprising:
a rotation supporter for rotatably supporting disc-shaped recording media each having a recording surface at least on one side with the recording surfaces oriented in the same direction; and
the optical pickup according to claim 4 arranged so that the condensers are disposed to be movable along the recording surfaces of the disc-shaped recording media.
